(19) United States
(12) Patent Application Publication
(10) Pub. No.: US 2004/0103037 A1
(43) Pub. Date: May 27, 2004

(54) Methods and apparatus for organizing retail product information

(75) Inventors: Andrew H. Wetmore, Geneva, IL (US); Dennis J. Honan, Cary, IL (US); James A. Tuchler, Northbrook, IL (US)

Correspondence Address: Thomas A. Miller, Michael Best & Friedrich LLP, 100 East Wisconsin Avenue, Milwaukee, WI, 53202-4108, US

(73) Assignee: Sears, Roebuck and Co., Hoffman Estates, IL

(21) Appl. No.: 10/304,265

(22) Filed: Nov. 26, 2002

(51) Int. Cl. G06F 17/60

(52) U.S. Cl. 705/26; 709/230

(57) ABSTRACT

Methods and apparatus for organizing product information online based on retail store purchases of the associated products are disclosed. The methods and apparatus described herein store product information, such as product identifiers, maintenance agreements, warranty information, and product manuals in a product information server database. Subsequently, actual product purchases are recorded by the product information server based on data from one or more point-of-sale terminals. Individual customers may then access product information associated with his purchases by going online, without the need to enter the product information or manually identify which products were purchased.

### TECHNICAL FIELD

The present invention relates in general to organizing retail product information and, in particular, to methods and apparatus for organizing product information online based on retail store purchases of the associated products.

### BACKGROUND

With the number of retail goods in consumer's homes greatly increasing, a need for manageable product warranties, maintenance agreements, owner's manuals, and other product information has emerged. Efficient use of many retail items, such as dishwashers and lawn mowers, requires more than just the initial purchase, installation, and use of the product. In addition, a consumer may need to repair a product, change a feature, etc. Unfortunately, by the time a consumer needs certain product information, the paper version which typically accompanies the product may be lost. As a result, the consumer may not know if the product is under warranty or how to operate a particular feature.

In response, some websites offer online versions of user's manuals. However, these websites suffer from certain drawbacks. First, the consumer must locate the product information that applies to his purchase, which may require extensive searching across several websites. Second, once located, the website may not have any product information beyond the user's manual. Third, unless the consumer entered the date of purchase and what warranty and/or service options were purchased, the website will be unable to determine the remaining time period and terms of his particular agreements.

### BRIEF DESCRIPTION OF THE DRAWINGS

Features and advantages of the disclosed system will be apparent to those of ordinary skill in the art in view of the detailed description of exemplary embodiments which is made with reference to the drawings, a brief description of which is provided below.

FIG. 1 is a high level block diagram of a communications system illustrating an exemplary environment of use for the present invention.

FIG. 2 is a more detailed block diagram of one of the client devices illustrated in FIG. 1.

FIG. 3 is a more detailed block diagram showing one embodiment of the product information server illustrated in FIG. 1.

FIG. 4 is a more detailed block diagram showing one embodiment of the point-of-sale terminal illustrated in FIG. 1.

FIG. 5 is a flowchart of a process for organizing product information online based on retail store purchases of the associated products.

### DETAILED DESCRIPTION OF EXEMPLARY EMBODIMENTS

In general, the system described herein stores product information, such as product identifiers, maintenance agreements, warranty information, and product manuals in a product information server database. Subsequently, actual product purchases are recorded by the product information server based on data from one or more point-of-sale terminals. Individual customers may then access product information associated with his purchases by going online, without the need to enter the product information or manually identify which products were purchased.

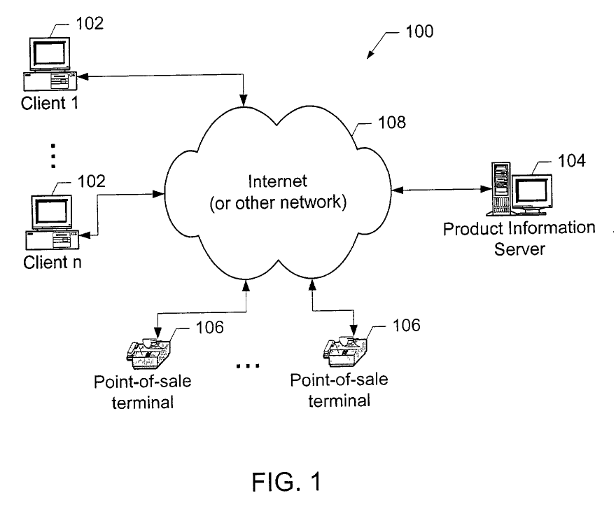

A high level block diagram of an exemplary network communications system 100 capable of employing the teachings of the present invention is illustrated in FIG. 1. Typically, the system 100 includes one or more client devices 102, one or more product information servers 104, and one or more point-of-sale terminals 106. Each of these devices may communicate with each other via a connection to one or more communications channels 108 such as the Internet or some other wide area network.

Typically, the product information server 104 stores a plurality of files, programs, and/or web pages for use by the client devices 102 and/or the point-of-sale terminals 106. One product information server 104 may interact with a large number of clients 102 and point-of-sale terminals 106. Accordingly, each server 104 is typically a high end computer with a large storage capacity, one or more fast microprocessors, and one or more high speed network connections. Conversely, relative to a typical server 104, each client device 102 and each point-of-sale terminal 106 typically includes less storage capacity, a single microprocessor, and a single network connection.

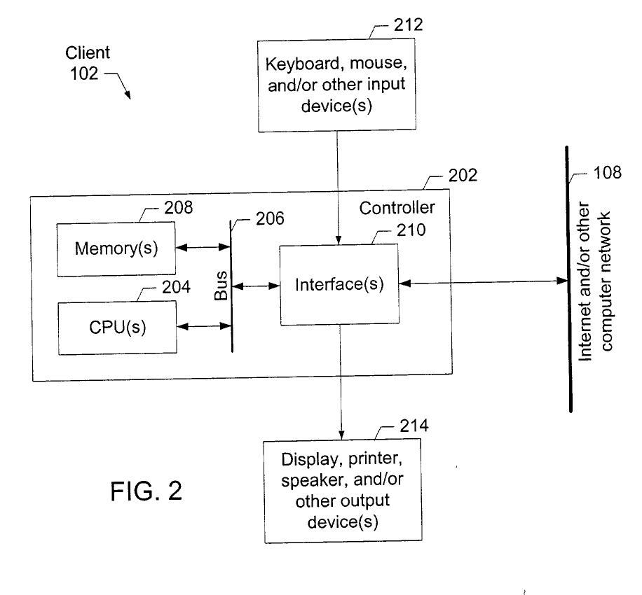

A more detailed block diagram of a client device 102 is illustrated in FIG. 2. The client device may be a personal computer (PC), a personal digital assistant (PDA), an Internet appliance, a cellular telephone, or any other communication device. The client 102 includes a controller 202 which preferably includes a central processing unit 204 electrically coupled by an address/data bus 206 to a memory device 208 and an interface circuit 210. The CPU 204 may be any type of well known CPU, such as an Intel PentiumTM processor. The memory device 208 preferably includes volatile memory and non-volatile memory. Preferably, the memory device 208 stores a software program that interacts with the product information server 104 as described below. This program may be executed by the CPU 204 in a well known manner. The memory device 208 may also store digital data indicative of documents, files, programs, web pages, etc. retrieved from a server 104, 106 and/or loaded via an input device 212.

The interface circuit 210 may be implemented using any type of well known interface standard, such as an Ethernet interface and/or a Universal Serial Bus (USB) interface. One or more input devices 212 may be connected to the interface circuit 210 for entering data and commands into the controller 202. For example, the input device 212 may be a keyboard, mouse, touch screen, track pad, track ball, isopoint, and/or a voice recognition system.

One or more displays, printers, speakers, and/or other output devices 214 may also be connected to the controller 202 via the interface circuit 210. The display 214 may be cathode ray tube (CRTs), liquid crystal displays (LCDs), or any other type of display. The display 214 generates visual displays of data generated during operation of the client 102. The display 214 is typically used to display web pages received from the product information server 104. The visual displays may include prompts for human operator input, run time statistics, calculated values, detected data, etc.

The client 102 may also exchange data with other devices via a connection to the network 108. The network connection may be any type of network connection, such as an Ethernet connection, digital subscriber line (DSL), telephone line, coaxial cable, etc. Users of the system 100 may be required to register with the product information server 104. In such an instance, each user may choose a user identifier and a password which may be required for the activation of services. The user identifier and password may be passed across the Internet 108 using encryption built into the user's browser. Alternatively, the user identifier and/or password may be assigned by the product information server 104.

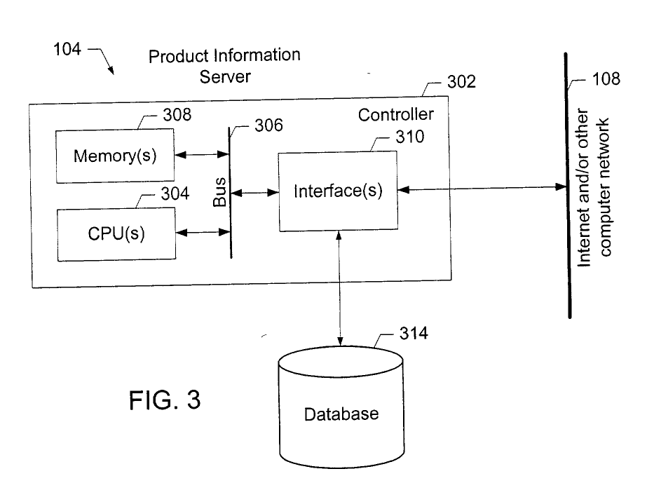

A more detailed block diagram of a product information server 104 is illustrated in FIG. 3. Like the client device 102, the controller 302 in the server 104 preferably includes a central processing unit 304 electrically coupled by an address/data bus 306 to a memory device 308 and a network interface circuit 310. However, the sever controller 302 is typically more powerful than the client controller 202. Again, the CPU 304 may be any type of well known CPU, such as an Intel PentiumTM processor, and the memory device 308 preferably includes volatile memory and non-volatile memory. Preferably, the memory device 308 stores a software program that implements all or part of the method described below. This program may be executed by the CPU 304 in a well known manner. However, some of the steps described in the method below may be performed manually or without the use of the server 104. The memory device 308 and/or a separate database 314 also store files, programs, web pages, etc. for use by other servers 104, point-of-sale terminals 106, and/or the client devices 102. Preferably the database 314 stores product information, customer information, purchase data, login data, request logs, and other data.

The server 104 may exchange data with other devices via a connection to the network 108. The network interface circuit 310 may be implemented using any data transceiver, such as an Ethernet transceiver. The network 108 may be any type of network, such as a local area network (LAN) and/or the Internet.

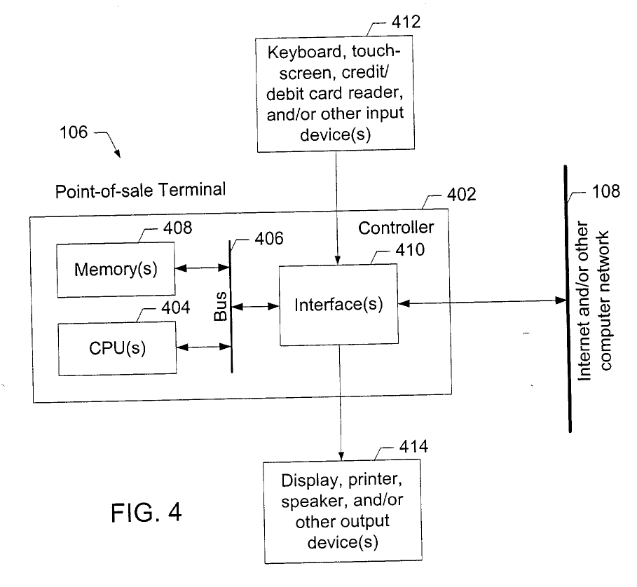

A more detailed block diagram of a point-of-sale terminal 106 is illustrated in FIG. 4. Preferably, the point-of-sale terminal 106 is a cash register and/or a personal computer executing point-of-sale software. The point-of-sale terminal 106 includes a controller 402 which preferably includes a central processing unit 404 electrically coupled by an address/data bus 406 to a memory device 408 and an interface circuit 410. The CPU 404 may be any type of well known CPU, such as an Intel PentiumTM processor. The memory device 408 preferably includes volatile memory and non-volatile memory. Preferably, the memory device 408 stores a software program that interacts with the product information server 104 as described below. This program may be executed by the CPU 404 in a well known manner. The memory device 408 may also store other data retrieved from a server 104 and/or loaded via an input device 412.

The interface circuit 410 may be implemented using any type of well known interface standard, such as an Ethernet interface and/or a Universal Serial Bus (USB) interface. One or more input devices 412 may be connected to the interface circuit 410 for entering data and commands into the controller 402. For example, the input device 412 may be a keyboard, mouse, touch screen, credit card reader, debit card reader, smart card reader, track pad, track ball, isopoint, and/or a voice recognition system.

One or more displays, printers, speakers, and/or other output devices 414 may also be connected to the controller 402 via the interface circuit 410. The display 414 may be cathode ray tube (CRTs), liquid crystal displays (LCDs), or any other type of display. The display 414 generates visual displays of data generated during operation of the point-of-sale terminal 106. The display 414 is typically used to display sales data during checkout of a retail customer. For example, the visual displays may include prompts for clerk input, customer input, running totals, product descriptions, etc.

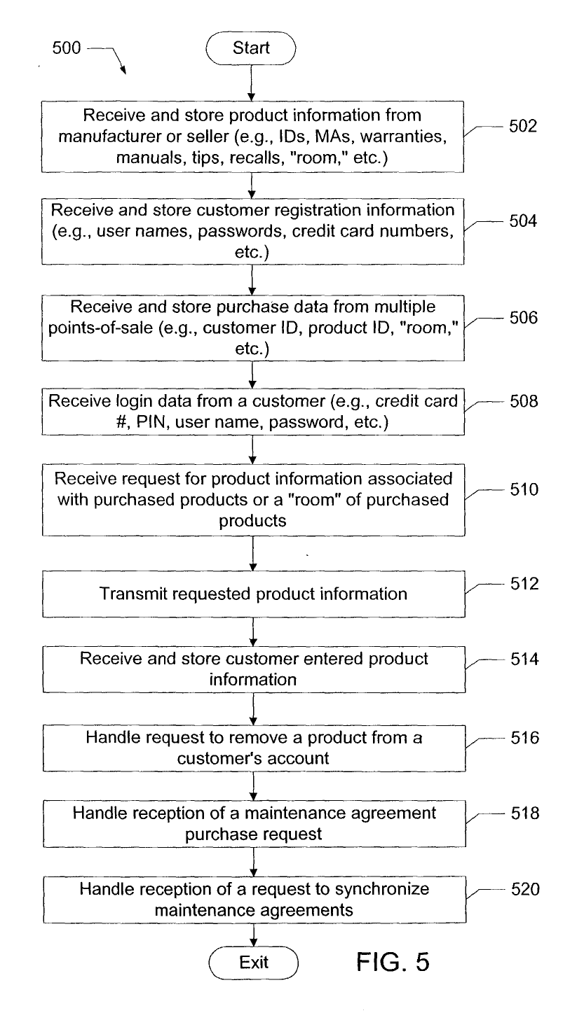

A flowchart of a process 500 for organizing product information online based on retail store purchases of the associated products is illustrated in FIG. 5. Preferably, the process 500 is embodied in a software program which is stored in the product information server memory 308 and executed by the server CPU 304 in a well known manner. However, some or all of the steps of the process 500 may be performed manually and/or by another device. Although the process 500 is described with reference to the flowchart illustrated in FIG. 5, a person of ordinary skill in the art will readily appreciate that many other methods of performing the acts associated with process 500 may be used. For example, the order of many of the steps may be changed without departing from the scope or spirit of the present invention. In addition, many of the steps described are optional.

Generally, the process 500 causes the product information server 104 to receive and store product information, such as product identifiers, maintenance agreements, warranty information, and product manuals in the product information server database 314. Subsequently, actual product purchases are recorded by the product information server 104 based on data from one or more point-of-sale terminals 106. Each customer may then access product information associated with his purchases by going online, without the need to enter the product information or manually identify which products were purchased.

The process 500 begins when the product information server 104 receives and stores product information from one or more product manufacturers and/or sellers (step 502). Preferably, the product information is received by the interface circuit 310 and stored in the database 314. Product information preferably includes product identifiers, maintenance agreements, warranty information, product manuals, troubleshooting tips, recall data, “room” designators, and/or any other data associated with the product(s) (step 502).

A product identifier is a digital string (i.e., numbers and/or letters) which distinguishes one product from another product. Some product identifiers uniquely identify the product (e.g., a serial number). Some product identifiers merely distinguish a type and/or family of products from another type and/or family of products (e.g., a model number). A maintenance agreement is a service contract which includes terms and/or conditions associated with the servicing of a product. For example, a customer may purchase an annual tune up for a lawn mower at the time s/he purchases the lawn mower. Similarly, a customer may receive an option for a maintenance service at a locked in price in exchange for purchasing the product. For example, a customer may receive “free” oil changes for five years with the purchase of an automobile.

Warranty information preferably includes one or more warranty durations and terms of coverage. For example, the engine of a lawn mower may be guaranteed for two years. Preferably, product manuals are digital versions of paper manuals (e.g., PDF files) including a table of contents, an index, diagrams, descriptions, etc. Troubleshooting tips are text descriptions and/or diagrams of what a customer may do on his own to resolve certain common problems. For example, if the engine of the lawn mower is not starting, the customer may be asked to check the fuel level, depress the primer, etc. Troubleshooting tips may be included I the manual.

Preferably, recall data include products identifiers of recalled products, information regarding the reason for the recall, a telephone number to contact with questions, and/or where to return the product. A “room” designator is a string which categorizes the product. For example, a number indicative of kitchen, laundry, entertainment, garage, tool shed, and/or yard may be used to group similar products together. The room designator facilitates online organization of purchased products as described in detail below.

In addition to product information, the product information server 104 preferably receives and stores customer registration information (step 504). Customer registration information preferably includes a unique customer identifier for each registered customer. For example, a user name, password, credit card number, and/or other identification string may be used as a customer identifier. In one embodiment, the customer enters the registration information via a client device 102. In another embodiment, the product information server 104 automatically registers a user in response to a customer identifier from a point-of-sale terminal 106. For example, the first time a customer purchasers a product from a retailer associated with the system 100, the point-of-sale terminal 106 may send a product identifier indicative of the purchased product (e.g., “Kenmore refrigerator Model # 12345A) and a customer identifier (e.g., the credit card number used to purchase the product) to the product information server 104 via the network 108. In response, the product information server 104 may create an account for the customer which includes the customer identifier and the product identifier.

In addition, the point-of-sale terminal 106 may print out a personal identification number (PIN) and/or instructions on how to access the automatically generated account. Further, the clerk operating the point-of-sale terminal 106 may be given on-screen instructions to explain usage of the new account to the customer. For example, the printed instructions and/or the displayed instructions may include a web address, an indication that the default user name is the credit card number used to make the purchase, and an indication that the default password is the PIN number. The PIN number may be generated by the server 104 or the point-of-sale terminal 106. The customer may change the username and password via a client device 102 after a successful login. In addition, customers using more than one credit card may consolidate accounts via a web page provided to a client device 102.

Product identifiers associated with subsequent purchases from associated retailers using the same credit card (or other customer ID) are automatically added to the existing account when a point-of-sale terminal 106 sends the additional product identifiers to the product information server 104 via the network 108 (step 506). In this manner, product information such as maintenance agreements, warranty information, product manuals etc. may be conveniently organized for a customer automatically based on actual customer purchases from retail stores. The user does not have to enter the product information or the product identifiers.

After one or more purchases are made, the customer may login to the product information server 104 in a well known manner (step 508). For example, the customer may enter his credit card number and PIN. Similarly, the customer may enter his usemame and password to login. In response to a successful login, a request for product information, and/or a request for a “room” of information (step 510), the product information server 104 preferably transmits the requested product information to the customer's client device 102 (step 512).

Once a customer is logged in, the product information server 104 may handle additional customer requests. For instance, the product information server 104 may receive and store customer entered product information (step 514). For example, the customer may enter a product identifier s/he would like added to his/her account that was not automatically entered (e.g., s/he paid cash or purchased the product from another retailer). Similarly, a customer may delete product information from his account (step 516). For example, a product which the customer no linger owns may be removed from the account.

In addition, the product information server 104 may handle reception of maintenance agreement purchase requests (step 518) and/or handle reception of a request to synchronize maintenance agreements (Step 520). For example, if a first maintenance agreement is set to expire in two months and a second maintenance agreement is set to expire in six months, the customer may which to extend the first maintenance agreement by fourteen months and the second maintenance agreement by ten months so that both maintenance agreements expire at the same time.

Still further, the product information server 104 may be programmed to transmit an e-mail message to a client device 102 prior to an expiration date associated with product information and/or in response to a product recall. Preferably, the e-mail message includes at least a portion of the product information and the relevant date. Optionally, individual customers may enable or disable this notification function.

In summary, persons of ordinary skill in the art will readily appreciate that a method and apparatus for organizing product information online based on retail store purchases of the associated products has been provided. Users of systems implementing the teachings described herein can enjoy easy access to online product information, such as maintenance agreements, warranty information, and product manuals, without the need to enter the product information or manually identify which products were purchased.

The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description, but rather by the claims appended hereto.

What is claimed is:

1. A method of organizing retail product information, the method comprising the steps of:
receiving first product information associated with a first product, the first product information including a first product identifier and at least one of a first product maintenance agreement, a first product warranty, a first product owner's manual, first product troubleshooting tips, a first product parts list, and first product recall information;
receiving second product information associated with a second product, the second product information including a second product identifier and at least one of a second product maintenance agreement, a second product warranty, a second product owner's manual, second product troubleshooting tips, a second product parts list, and second product recall information;
receiving third product information associated with a third product, the third product information being different than the first product information, the third product information including a third product identifier and at least one of a third product maintenance agreement, a third product warranty, a third product owner's manual, third product troubleshooting tips, a third product parts list, and third product recall information;
receiving first customer registration information from a first customer, the first customer registration information including a first customer identifier;
receiving second customer registration information from a second customer, the second customer registration information including a second customer identifier;
receiving first purchase data from a first point-of-sale device in response to a first retail purchase of the first product by the first customer, the first purchase data including the first product identifier and the first customer identifier;
receiving second purchase data from a second point-of-sale device in response to a second retail purchase of the second product by the second customer, the second purchase data including the second product identifier and the second customer identifier, the second point-of-sale device being different than the first point-of-sale device, the second customer identifier being different than the first customer identifier;
receiving third purchase data from a third point-of-sale device in response to a third retail purchase of the third product by the first customer, the third purchase data including the third product identifier and the first customer identifier, the third point-of-sale device being different than the first point-of-sale device and the second point-of-sale device;
receiving login data from a Internet client device, the login data including the first customer identifier; and
transmitting at least a portion of the first product information and at least a portion of the third product information to the Internet client device in response to receiving the login data from the Internet client device.

2. A method as defined in claim 1, wherein the step of receiving first customer registration information including a first customer identifier comprises receiving a credit card number.

3. A method as defined in claim 1, further comprising the step of transmitting an e-mail message to the Internet client device prior to an expiration date associated with the first product information, the e-mail message including at least a portion of the first product information and the expiration date.

4. A method as defined in claim 1, further comprising the step of transmitting an e-mail message to the Internet client device, the e-mail message including at least a portion of the first product information and a product recall notice.

5. A method as defined in claim 1, further comprising the step of receiving fourth product information from the Internet client device, the fourth product information being manually entered into the Internet client device by the first customer.

6. A method as defined in claim 5, wherein the step of receiving fourth product information includes the step of receiving a date associated with a maintenance event.

7. A method as defined in claim 1, further comprising the step of receiving a maintenance agreement purchase request from the Internet client device.

8. A method as defined in claim 7, further comprising the step of receiving a request to synchronize maintenance agreements associated with the first product and the third product.

9. A method as defined in claim 8, further comprising the step of transmitting an end date associated with request to synchronize.

10. A method as defined in claim 1, further comprising the step of allowing the first customer to remove the first product identifier from an account associated with the first customer.

11. A method as defined in claim 1, further comprising the step of storing the first product information in association with a room identifier.

12. A method as defined in claim 11, wherein the step of storing the first product information comprises the step of storing the first product information in association with a room identifier, the room identifier being inductive of at least one of kitchen, laundry, entertainment, garage, tool shed, and yard.

13. A method as defined in claim 11, wherein the step of transmitting at least a portion of the first product information and at least a portion of the third product information to the Internet client device comprises the step of transmitting data indicative of the room identifier.

14. An apparatus structured to organize retail product information, the apparatus comprising:
an Internet receiver;
an Internet transmitter
a processing unit operatively coupled to the Internet receiver and the Internet transmitter; and
a memory device operatively coupled to the processing unit, the memory device storing a software program structured to cause the processing unit to:
receive first product information associated with a first product via the Internet receiver, the first product information including a first product identifier and at least one of a first product maintenance agreement, a first product warranty, a first product owner's manual, first product troubleshooting tips, a first product parts list, and first product recall information;
receive second product information associated with a second product via the Internet receiver, the second product information being different than the first product information, the second product information including a second product identifier and at least one of a second product maintenance agreement, a second product warranty, a second product owner's manual, second product troubleshooting tips, a second product parts list, and second product recall information;
receive customer registration information via the Internet receiver, the customer registration information including a customer identifier;
receive first purchase data from a first point-of-sale device in response to a first retail purchase of the first product by the first customer, the first purchase data including the first product identifier and the customer identifier;
receive second purchase data from a second point-of-sale device in response to a second retail purchase of the second product by the second customer, the second purchase data including the second product identifier and the customer identifier, the second point-of-sale device being different than the first point-of-sale device;
receive login data via the Internet receiver from a Internet client device, the login data including the customer identifier; and
transmit at least a portion of the first product information and at least a portion of the second product information to the Internet client device via the Internet transmitter in response to receiving the login data from the Internet client device.

15. An apparatus as defined in claim 14, wherein the software program is further structured to cause the processor to transmit an e-mail message to the Internet client device prior to an expiration date associated with the first product information, the e-mail message including at least a portion of the first product information and the expiration date.

16. An apparatus as defined in claim 14, wherein the software program is further structured to cause the processor to transmit an e-mail message to the Internet client device prior to an expiration date associated with the first product information, the e-mail message including at least a portion of the first product information and a product recall notice.

17. An apparatus as defined in claim 14, wherein the software program is further structured to cause the processor to receiving third product information from the Internet client device, the third product information being manually entered into the Internet client device.

18. An apparatus as defined in claim 14, wherein the software program is further structured to cause the processor synchronize an end date associated with the fist product maintenance agreement and the second product maintenance agreement.

19. An apparatus as defined in claim 14, wherein the software program is further structured to cause the processor delete the first product identifier from a customer account.

20. An apparatus as defined in claim 14, wherein the software program is further structured to cause the processor store the first product information in association with a room identifier, the room identifier being inductive of at least one of kitchen, laundry, entertainment, garage, tool shed, and yard.
